(19) United States
(12) Patent Application Publication
(10) Pub. No.: US 2016/0191531 A1
(43) Pub. Date: Jun. 30, 2016

(54) METHOD FOR FILE SCRUBBING IN A SECURITY GATEWAY FOR THREAT PREVENTION

(71) Applicant: CHECK POINT SOFTWARE TECHNOLOGIES LTD, Tel Aviv (IL)

(72) Inventors: Amnon Perlmutter, Givataim (IL); Limor Ganon, Ramat Hasharon (IL); Lior Drihem, Givat Shmuel (IL); Lior Tamim, Zichron Yaakov (IL)

(21) Appl. No.: 14/583,828

(22) Filed: Dec. 29, 2014

(51) Int. Cl. H04L 29/06

(52) U.S. Cl. CPC H04L 63/101; H04L 63/20

(57) ABSTRACT

Methods and systems for blocking reception of digital content elements by devices are disclosed. These methods and systems comprise elements of hardware and software for, receiving an electronic communication including at least one digital document; determining the content type of the at least one digital document; based on the content type of the at least one digital document, modifying the digital content of the digital document so as to selectively disable functionality of the digital document; and, enabling the subsequent processing of the electronic communication including the at least one digital document with the modified digital content.

### TECHNICAL FIELD OF THE INVENTION

The present invention relates to methods and systems for preventing entry of harmful digital content into an organization's networks and connected machines.

### BACKGROUND

Electronic communications can include viruses or other harmful digital content. Frequently this harmful content appears in files that enter organizations via emails, downloads, or other necessary and legitimate communication channels. These files are sometimes opened by recipients, which can result in infection, disruption, or other undesirable effects on the receiving computer or other targets inside the organization.

### SUMMARY OF THE INVENTION

The present invention provides methods and systems for intercepting electronic communications, neutralizing or removing potentially harmful digital content from the communications, completing the transmission of communications with the potentially harmful content neutralized or removed. Additionally, conditional retrieval of the original unmodified content from a server (by a user) is enabled.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

A “document” is a grouping of digital content associated with a particular type of content and particular digital format. Examples include: ASCII text in an email, a video file in MPEG-4 (Moving Picture Experts Group) format, a database dumped in XML (Extensible Markup Language), a Microsoft® Word® document, a web page in HTML (Hypertext Markup Language), a hierarchy of web content in a zip file etc. Note that this definition includes a broad range of file types including some that might not be described as documents in the conventional sense of the term.

“Document type” refers to the digital formats associated with a particular document e.g. MPEG-4 video, XML etc.

The term “embedded content element” refers to a smaller grouping of digital content that is contained within a larger document and conveys particular information or performs a particular function when the document is utilized. For example, the embedded content elements in a Microsoft Word document may include images, text, formatting information and macros. Embedded content elements may occur as a particular sequence of bits within a digital document, or as multiple sequences of bit data spread across a document, or the like. Embedded content elements may themselves contain embedded content elements (i.e. there may be a hierarchy of embedded content elements).

The term “Embedded content element type” refers to the digital format associated with a particular embedded content element e.g. PNG (Portable Network Graphics) image, JavaScript, Microsoft Word macro.

Embodiments of the present invention are directed to a method, which is computer-implemented, for blocking reception of digital content elements by devices. The method comprises: receiving an electronic communication including at least one digital document; determining the content type of the at least one digital document; and, based on the content type of the at least one digital document, modifying the digital content of the at least one digital document so as to selectively disable functionality of the at least one digital document.

Optionally, the method additionally comprises: transmitting the electronic communication including the modified at least one digital document to the intended recipient.

Optionally, the method additionally comprises: storing the unmodified at least one digital document on a document repository server.

Optionally, the method additionally comprises: facilitating user access to the original at least one digital document residing on the document repository server.

Optionally, the method additionally comprises: modifying the received electronic communication to inform the user of the availability on the document repository server of the received at least one digital document.

Optionally, the method additionally comprises: performing additional operations on the received at least one digital document to assess whether the received at least one digital document should be allowed to the user, and determining user access to the received at least one digital document based on the result of the additional operations.

Optionally, the modifying the digital content of the at least one digital document, comprises: identifying at least one embedded content element in the at least one digital document; identifying the embedded content element type of the at least one embedded content element; and, based on the identified embedded content element type, deleting the embedded content element.

Optionally, the method additionally comprises: subsequently modifying the digital content of the at least one digital document such that the at least one digital document is at least partially usable following the removal of embedded content elements.

Optionally, the modifying the digital content of the at least one digital document is modified by replacing the received at least one digital document with a newly created digital document.

Optionally, the newly created digital document is of a document type that is different from the document type of the received at least one digital document.

Optionally, the electronic communication is electronic mail (email).

Optionally, the electronic communication is a HTTP (Hypertext Transfer Protocol) download.

Optionally, the electronic communication is a FTP (File Transfer Protocol) download.

Optionally, the electronic communication received at the gateway is part of an exchange conducted by an interactive application that allows for sending/sharing files.

Optionally, the embedded content element types to be deleted have been predetermined according to an evaluation of whether each embedded content element type constitutes a security threat to the recipient.

Embodiments of the present invention are directed to a computer system for blocking reception of digital content elements. The computer system comprises: a storage medium for storing computer components; and a computerized processor for executing the computer components. The computer components comprise: a first computer component configured receiving an electronic communication including at least one digital document; a second computer component for determining the content type of the at least one digital document; and, a third computer component for, based on the content type of the at least one digital document, modifying the digital content of the at least one digital document so as to selectively disable functionality of the at least one digital document.

Optionally, the computer system additionally comprises: a fourth computer component for transmitting the electronic communication including the modified at least one digital document to the intended recipient.

Embodiments of the present invention are directed to a computer-usable non-transitory storage medium having a computer program embodied thereon for causing a suitable programmed system to block reception of digital content elements, by performing the following steps when such program is executed on the system. The steps comprise: receiving an electronic communication including at least one digital document; determining the content type of the at least one digital document; and, based on the content type of the at least one digital document, modifying the digital content of the at least one digital document so as to selectively disable functionality of the at least one digital document.

Optionally, the storage medium additionally performs the step of: transmitting the electronic communication including the modified at least one digital document to the intended recipient.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a system environment in which an embodiment of the invention is deployed;

FIG. 2 is a diagram of the architecture of an exemplary gateway machine utilizing the invention;

FIG. 3 is a flow diagram showing the process of handling an email when the invention is embodied by an email gateway;

FIG. 4 is a flow diagram showing the process of mitigating threats in an email attachment when the invention is embodied in an email gateway;

FIG. 5 is a flow diagram showing the actions taken by a server upon receiving an original unmodified version of a document from the security gateway; and,

FIG. 6 is a flow diagram showing the actions taken by a server when a user attempts to access an original unmodified version of a document.

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

The present invention may be embodied in a system, method or computer program product. Accordingly, aspects of the present invention may take the form of an entirely hardware embodiment, an entirely software embodiment (including firmware, resident software, micro-code) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

The invention provides, in various embodiments, methods and systems for preventing entry of harmful digital content into an organization's networks and connected machines. The invention is described in detail and exemplarily for an email gateway which mitigates against harmful email attachments. Such a system may be, for example, a web proxy which mitigates against harmful webpages and files downloaded via HTTP (Hypertext Transfer Protocol).

Some embodiments of the present invention are directed to a security gateway which receives entails entering into an organization. Emails frequently include attached documents of various types e.g. Microsoft Word or compressed Zip archives. Some of these document types may include embedded content elements (e.g., Word documents may include Word macros, or Zip archives may include executable files).

In such embodiments, the security gateway “scrubs” potentially harmful documents in entails that are received. By “scrubs” it is meant that the Gateway performs one or more of: a) replacing some or all of the digital document content with different content that conveys all or some of the information or utility present in the original content, b) neutralizing or disabling potentially harmful embedded content elements in the digital document, and, c) removing potentially harmful embedded content elements from the digital document in a manner which leaves the rest of the content at least partially usable or readable by the intended recipient(s).

The security gateway then transmits the email, formerly with the potentially harmful attached documents having been replaced with the “scrubbed” documents, to the intended recipient(s).

Optionally, the gateway stores the original non-scrubbed document on a server for further processing and/or user access. Also optionally, the gateway modifies the email before transmission to indicate to the recipient how he can access the original document.

In this manner, the potential of attacking though the email channel has been mitigated, and legitimate use of the email channel has been only minimally impacted.

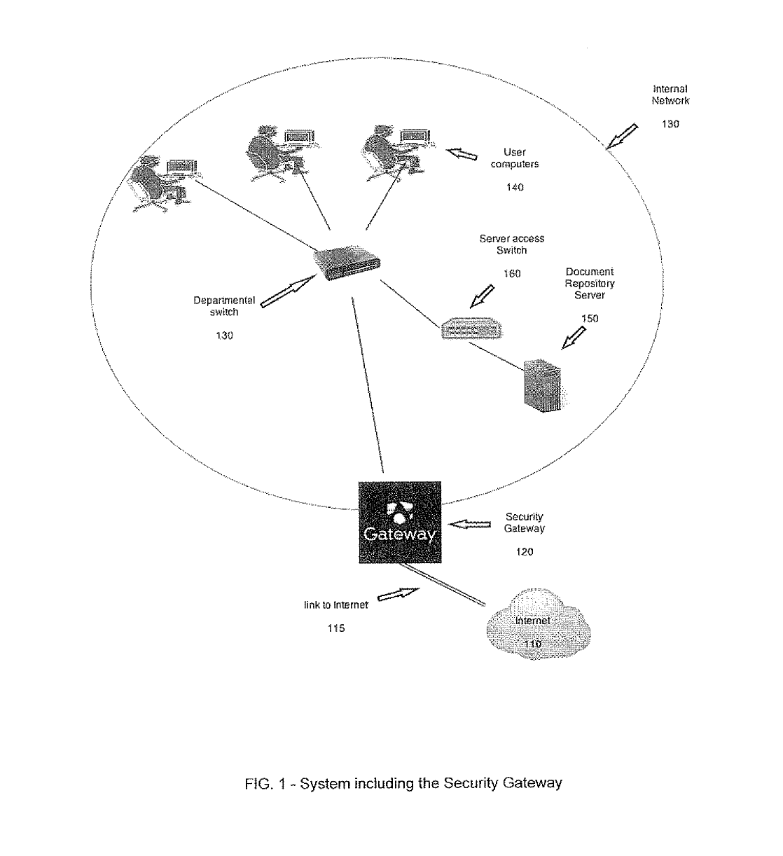

Reference is now made to FIG. 1, which shows an exemplary system environment including a Security Gateway 120 which connects via network link 115 to a network 110, for example the internet. The network link is a broadband or WAN (Wide Area Network) connection, LAN (Local Area Network) connection, or other link to an entrusted portion of the organization's private network or other channel which can be the origin of threatening communications.

The Security Gateway 120 also connects to an internal network 130 to which the user computers 140 that are to be protected are linked. The user computers 140 may also be, for example, smartphones, tablets, or other types of devices used for accessing email and other electronic communications, and may, for example, be remotely located, for example, when they are attached via a Virtual Private Network (VPN). Similarly, the network 110 may include wireless segments or include heterogeneous wired components. Emails arrive from the internet 110 to the security gateway 120, and following mitigation and/or neutralization of potentially harmful digital content as described herein, the emails are distributed or made available to the users (via user computers 140).

A Document Repository Server 150 linked to the network 100, serves to receive the original versions of documents that are subsequently modified by the Security Gateway 110. Users or administrators may subsequently request access to the original documents. The Document Repository Server 150 typically resides in the organization's internal network. Alternatively, the document repository server can be, for example, collocated with the security gateway (e.g. a separate component residing within the same physical enclosure or implemented as a separate software module)

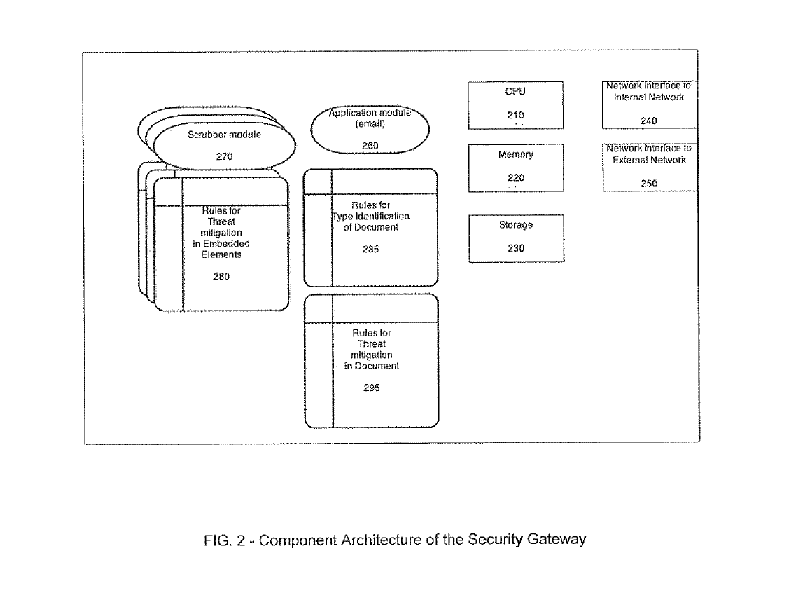

The internal architecture of the security gateway 120 is shown in FIG. 2. The gateway 120 includes a central processing unit (CPU) 210 formed of one or more processors, electronically connected, including in electronic and/or data communication with memory 220, storage 230, network interfaces 240 and 250, application module 260, scrubber modules 270, and rules tables 280, 290, 295.

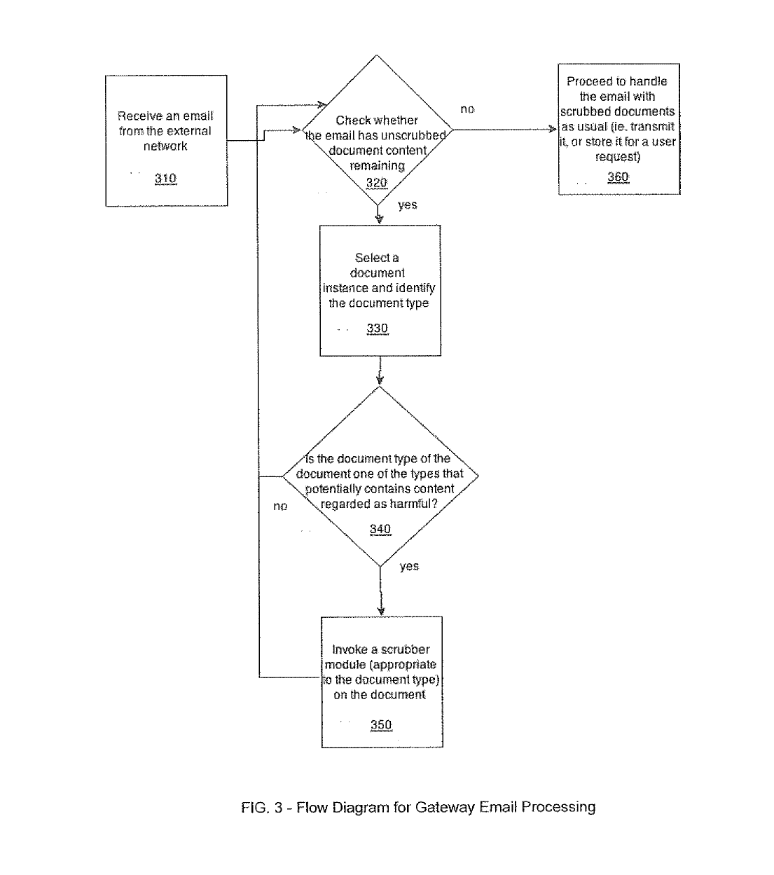

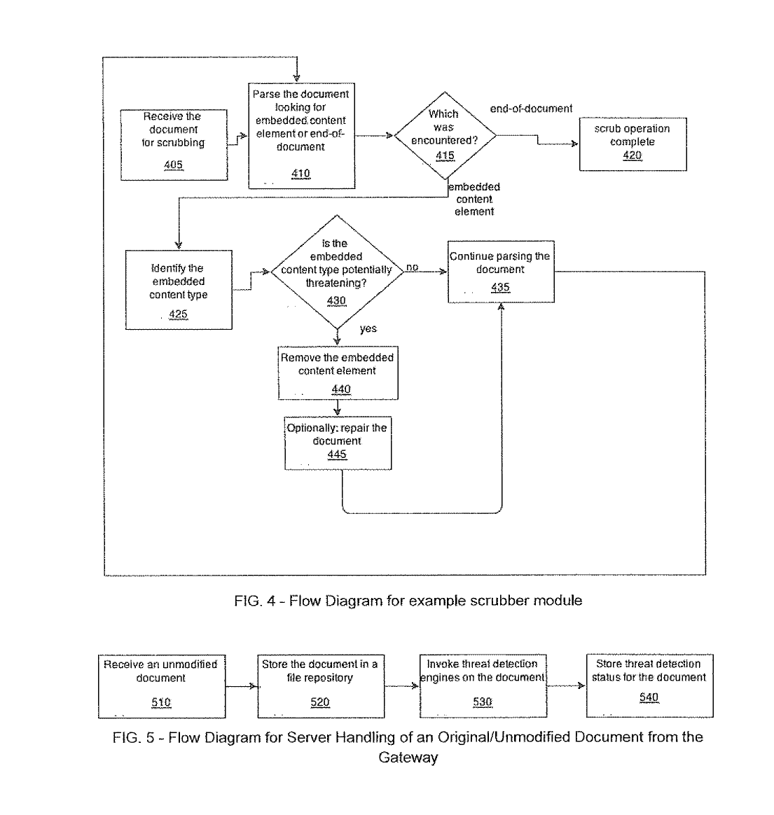

The Central Processing Unit (CPU) 210 is formed of one or more processors, including physical or virtual microprocessors, for performing the gateway 120 functions and operations detailed herein, including controlling the memory 220, storage 230, network interface to internal network 240, network interface to external network 250, rules tables 280, 285, and 295, application module 260, and scrubber modules 270, along with the processes shown in FIGS. 3 and 4, and detailed below. The processors are, for example, conventional processors, such as those used in servers, computers, and other computerized devices. For example, the processors may include x86 Processors from AMD and Intel, Xeon® and Pentium® processors from Intel, as well as any combinations thereof.

The memory 220 is any conventional memory media. The memory 220 stores machine executable instructions associated with the operation of the components, including, network interfaces 240 and 250, rules tables 280, 285, and 295, application module 260 and scrubber modules 270 and all instructions for executing the processes of FIGS. 3 and 4 detailed herein. The processors of the CPU 210, memory 220, and storage 230 although each shown as a single component for representative purposes, may be multiple components, and may be outside of the security gateway 120, and linked to the internal network 130 or internet 110.

The network interface to the internal network 240 is a physical, virtual, or logical data link for communication with computers inside the organization. Similarly, the network interface to the external network 250 is a physical, virtual, or logical data link for communication with computers outside the organization for example on the internet. Alternatively, a gateway may use a single network interface to both the internal and external networks in conjunction with Virtual Local Area Networks (VLANs) or the like.

The architecture includes a number of application-related modules. The module for the email application module 260 performs, for example, email handling functionalities such as receiving mail from outside the internal network, storing the mail, authenticating requests from internal users, forwarding mail to internal users etc. Additionally, the email application module 260 identifies documents in email and determines if they need to be scrubbed to eliminate potentially harmful digital content. This latter procedure is described in detail with reference to FIG. 3.

The email application module 260 utilizes two data structures in its processing. The first data structure 285 stores document type identification information and associates it with a document type identifier. For example, should the embodiment utilize the filename extension for document type identification, this data structure may include a mapping between the extension “.doex” and an identifier denoting a Microsoft Word file. The second data structure 295 stores information regarding the whether the document type is regarded as potentially harmful, and what treatment should be applied to the document if it is in fact potentially harmful. For example, there may be an entry in the data structure indicating that a document of type Microsoft Word requires treatment by a content-element-deleting scrubber module (described in detail below).

The data structure mechanism described here for the email application module 260 is exemplary, as there are multiple processes for implementing the disposition of documents according to their types.

There are typically one or more scrubber modules 270. Each scrubber module 270 is assigned to convert a potentially harmful digital document of a particular document type into a non-threatening document.

A scrubber module 270 may use one or more methods to accomplish this conversion. Scrubbing methods include, for example, scanning through the digital content of the document in search of embedded content elements, and delete embedded content elements that are potentially harmful, and repair the document so that it is partially or fully usable. Such a scrubber module is termed a “content-element-deleting” scrubber module.

Each content-element-deleting scrubber module utilizes, for example, a data structure 280 in its processing. The data structure 280 contains a table which lists embedded content element types that can appear in a document of the particular document type and specifies if the embedded content type element is regarded as potentially harmful. For example, a scrubber module instance associated with Microsoft® Word® documents may have an associated table listing mappings between the embedded content element types that may appear in Microsoft® Word® documents and how such embedded content elements should be handled e.g. the table entry may indicate that embedded content elements including Word® macros are regarded as potentially harmful and thus subject to deletion (as described in further detail below). The table may have an entry to indicate the handling for an embedded content element whose embedded content element type is unrecognized.

The determination of which embedded content element types are regarded as potentially harmful is predetermined or previously designated. Alternatively, the determination may be configurable and left to the system administrator.

The data structure mechanism for the content-element-deleting scrubber module 270 is exemplary. There are many different ways for a content-element-deleting Scrubber module 270 to determine the disposition of embedded content element types, such as a mathematical formula, linked list, and the like.

The procedure followed by the email application module 260 for preventing the entry of potentially harmful digital content is shown in FIG. 3. The procedure begins in block 310, in which the email application module receives an email message from outside the network. The email is received, for example, via SMTP (Simple Mail Transfer Protocol) from the network 110, for example, the Internet, via the external network link 115 of the gateway 120.

The email that has been received may contain harmful content, for example as an email attachment. In the following description, the term “document” is used to mean any component or content of the email, and not merely attached documents as conventionally understood. For example, the text of the email can be regarded as a document.

In block 320, the email application module 260 looks for thus-far-unchecked content, for example in the faun of documents attached to the email that have not yet undergone processing. In block 330, the module selects an unprocessed document and identifies the document type (for example Microsoft® Word®, HTML etc.). The application module may, for example, identify the document type by simply by examining a filename extension associated with the document, since filename extensions such as .docx or .htm commonly denote Microsoft® Word® and HTML documents respectively. Alternatively, the email application module 260 may, for example, determine the document type by examining the digital content or magic signature of the document itself, or by examining MIME (Multipurpose Internet Mail Extension) headers contained in the email.

In block 340 the email application module 260 determines whether the document type is potentially harmful. The email application module 260 performs this determination, for example, by maintaining a table of document types (as shown in block 285 in FIG. 2) with indications of whether each document type is considered potentially harmful. The email application module then checks the table and evaluates whether the identified document type is regarded as potentially harmful. If so, control moves to block 350 and the document undergoes processing by a scrubber module 270 that is appropriate to the identified document type. If the document is not regarded as potentially harmful, it is not altered, and control returns to block 320. In block 320 if there are additional documents to be processed, the procedure repeats again.

In block 320 the email application module 260 completes processing of the email provided all the documents of the email have been processed. In this case control proceeds to block 360 where the email is returned to other processing, for example, it is forwarded or stored according to the gateway's 120 email handling functionality. Alternatively, the email application module may determine that the email should be blocked and not forwarded.

This mechanism for evaluation of documents is exemplary, and other methods may be utilized. For example, documents of zero or very-short length might be automatically regarded as not potentially harmful.

The procedure followed by an example content-element-deleting scrubber module 270 is shown in FIG. 4.

The content-element-deleting scrubber module 270 is designed for a particular document type (for example a Microsoft Word document). FIG. 4 describes the procedure followed by a content-element-deleting scrubber module in a generic and document-type-independent manner.

In block 405, the scrubber module 270 receives the document from, for example, the email application module (block 260 in FIG. 2). In block 410, the scrubber module 270 begins to parse the document by seeking the first embedded content element. This parsing may, for example, consist of reading through the document in a byte-by-byte manner to identify the different components by matching bit patterns used in the specific document type to identify embedded elements. Alternatively it may, for example, make use of a content map which appears at the beginning of a document of the particular document type and specifies byte offsets in the document where embedded elements occur. Alternatively, in some document types, the embedded content elements might be found at fixed well-known offsets in the document file. Many other mechanisms for locating embedded content elements are possible.

For some document types, embedded content elements may have a certain data length in bytes (not necessarily known at the time that the element is identified), and may then be followed in the data by a subsequent embedded content element. For some document types, embedded content elements may themselves have content elements embedded within them (i.e. there may be hierarchies of embedded content elements).

In block 410, the content-element-deleting scrubber module parses the document looking for either an embedded content element or the end of the document. In block 415 the scrubber evaluates the result of the parsing. If an embedded content element is found, control proceeds to block 425 and the content-element-deleting scrubber module identifies the type of the embedded content element. The content-element-deleting scrubber module accomplishes this identification, for example, by comparing the initial byte of the embedded content element with a known pattern that is used in a document of the particular document type to mark the beginning of an embedded content element of a particular embedded content element type.

As detailed above, the types of embedded content elements which might occur are particular to the document type being scrubbed. Examples of embedded content element types that the scrubber may encounter when parsing e.g. a Word document may include: text, fonts, titles, macros.

Having identified an embedded content element and its embedded content element type, the content-element-deleting scrubber module in block 430 determines if the identified embedded content type is one that is regarded as potentially harmful. The scrubber module accomplishes this, for example, by maintaining a table of embedded content element types (as shown in block 280 in FIG. 2) with indications of whether each embedded content element type is considered potentially harmful.

In the case where the content-element-deleting scrubber module determines that the embedded content element type is potentially harmful, control moves to block 440. The content-element-deleting scrubber module proceeds to eliminate the embedded content element, for example, by removing the bits of digital content that constitute the embedded content element (for example: from the element's beginning to its end) from the document.

In block 445 the content-element-deleting scrubber module optionally performs whatever repairing it can perform to the document so that the remaining content of the document is partially or fully usable by a user after the potentially harmful embedded content element has been removed. Many methods are possible for the repair procedure. Generally the requirements of the repair procedure are specific to the document type.

In block 435 the content-element-deleting scrubber module returns to parsing the document in search of additional embedded content elements.

Returning now to block 415, when the content-element-deleting scrubber module reaches the end of the document, it moves to block 420 to complete its processing.

The scrubber module 270 described above performs a content-element-deleting operation to prevent entry of potentially harmful digital content. Alternatively, a scrubber module may neutralize or disable potentially harmful embedded content elements rather than removing them (for example: modifying the bits of a Word Macro so that it will not be executed). Alternatively, a scrubber module may determine that a document should be deleted rather than modified (for example after partially processing the document).

Alternatively, a scrubber module may create a new replacement document (of the same document type as the original document or of a different document type) consisting only of non-potentially-harmful content. For example, a scrubber module may create a new replacement Word document consisting of the content of the original document except for the potentially harmful elements. Alternatively, a scrubber module may create a replacement Acrobat document that includes content taken from an original Word document.

FIG. 5 shows the procedure executed by, for example, the document repository server 150 for handling the optional reception of an original unmodified document from, for example, the security gateway 120 during the gateway's email processing. In block 510, the unmodified document is received by the repository server. This can be accomplished by the File Transfer Protocol (FTP) or other data transmission mechanisms. Next in block 520 the server 150 stores the document in a database, hierarchical file system, or other repository so that it can be accessed later in response to user or administrator request. Next (and optionally) in block 530 the server invokes threat detection engines such as antivirus or other malware detection programs on the document. Finally in block 540, the server records the threat status of the document for use later on.

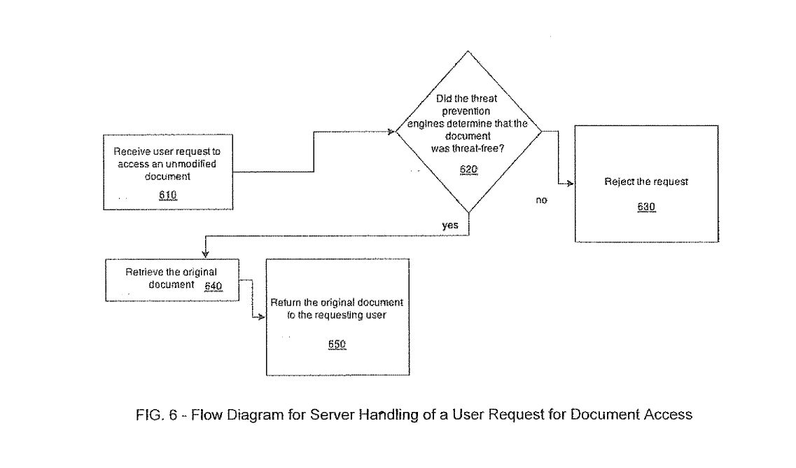

FIG. 6 specifies the procedure executed by, for example, the document repository server 150 to handle the optionally supported user request for an original unmodified document. In block 610, the server receives the user request, which arrives, for example, over web-based interface or FTP (File Transfer Protocol) or a. In block 620, the server optionally checks whether the document was determined to be threat-free at the time that the threat detection engines were invoked. If so, then in block 640 the document is retrieved and in block 650 it is returned to the requesting user (for example: over the same FTP channel or web-based interface where the request was issued). However, should the document be found to contain threats, then in block 630 the request is rejected.

The steps described in FIGS. 5 and 6 are exemplary and variations on the procedure are possible. For example, an embodiment may invoke the threat prevention engines only in response to a user request for the document (block 610) and not subsequent to storing the document (block 520). In this case, the repository server may send a message to the user to wait until the engines complete operation and the document may be labeled as safe or unsafe. Also for example, a potentially harmful document may be deleted by the repository server rather than be stored and labeled.

The invention has been described in detail for an embodiment that is directed to handling threats in email documents. Nevertheless, the methods of the invention can be employed to mitigate harmful digital content arriving over other communication channels.

For example, the invention can be embodied in a system where a security gateway 120 includes a web proxy application module in the place of the email application module 260. In such a system, the web proxy application module receives HTTP requests from user computers, reinitiates the requests toward the target servers on the internet, receives requested data from the target servers, and builds HTTP responses to be sent back to the user computers.

In such a web proxy system, the neutralization/removal of harmful digital content is performed in a manner analogous to the one used in the email system described above—with the HTTP communication channel being used rather than the email channel. Documents received via HTTP are scanned and then document-type-specific scrubbers are employed. Potentially harmful documents are replaced with scrubbed documents. Original documents are optionally made available on the document repository server. The server sends notifications to users via modification to the web documents rather than modifications to the email documents.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for blocking reception of digital content elements by devices, comprising:
a) receiving an electronic communication including at least one digital document;
b) determining the content type of the at least one digital document; and,
c) based on the content type of the at least one digital document, modifying the digital content of the at least one digital document so as to selectively disable functionality of the at least one digital document.

2. The method of claim 1, additionally comprising: transmitting the electronic communication including the modified at least one digital document to the intended recipient.

3. The method of claim 1, additionally comprising: storing the unmodified at least one digital document on a document repository server.

4. The method of claim 3, additionally comprising: facilitating user access to the original at least one digital document residing on the document repository server.

5. The method of claim 4, additionally comprising: modifying the received electronic communication to inform the user of the availability on the document repository server of the received at least one digital document.

6. The method of claim 4, the method additionally comprising: performing additional operations on the received at least one digital document to assess whether the received at least one digital document should be allowed to the user, and determining user access to the received at least one digital document based on the result of the additional operations.

7. The method of claim 1, wherein the modifying the digital content of the at least one digital document, comprises:
a) identifying at least one embedded content element in the at least one digital document;
b) identifying the embedded content element type of the at least one embedded content element; and,
c) based on the identified embedded content element type, deleting the embedded content element.

8. The method of claim 7, additionally comprising: subsequently modifying the digital content of the at least one digital document such that the at least one digital document is at least partially usable following the removal of embedded content elements.

9. The method of claim 1, wherein the modifying the digital content of the at least one digital document is modified by replacing the received at least one digital document with a newly created digital document.

10. The method of claim 9, where the newly created digital document is of a document type that is different from the document type of the received at least one digital document.

11. The method of claim 1, where the electronic communication is electronic mail (email).

12. The method of claim 1, where the electronic communication is a HTTP (Hypertext Transfer Protocol) download.

13. The method of claim 1, where the electronic communication is a FTP (File Transfer Protocol) download.

14. The method of claim 1, where the electronic communication received at the gateway is part of an exchange conducted by an interactive application that allows for sending/sharing files.

15. The method of claim 7, where the embedded content element types to be deleted have been predetermined according to an evaluation of whether each embedded content element type constitutes a security threat to the recipient.

16. A computer system for blocking reception of digital content elements, comprising:
a storage medium for storing computer components; and
a computerized processor for executing the computer components comprising:
a first computer component configured receiving an electronic communication including at least one digital document;
a second computer component for determining the content type of the at least one digital document; and,
a third computer component for, based on the content type of the at least one digital document, modifying the digital content of the at least one digital document so as to selectively disable functionality of the at least one digital document.

17. The computer system of claim 16, additionally comprising: a fourth computer component for transmitting the electronic communication including the modified at least one digital document to the intended recipient.

18. A computer-usable non-transitory storage medium having a computer program embodied thereon for causing a suitable programmed system to block reception of digital content elements, by performing the following steps when such program is executed on the system, the steps comprising:
a) receiving an electronic communication including at least one digital document;
b) determining the content type of the at least one digital document; and,
c) based on the content type of the at least one digital document, modifying the digital content of the at least one digital document so as to selectively disable functionality of the at least one digital document.

19. The storage medium of claim 18, additionally performing the step of: transmitting the electronic communication including the modified at least one digital document to the intended recipient.
